(19) United States
(12) Patent Application Publication
(10) Pub. No.: US 2008/0283503 A1
(43) Pub. Date: Nov. 20, 2008

(54) Method of Processing Nature Pattern on Expitaxial Substrate

(76) Inventors: Cheng-yi Liu, Jhongli City (TW); Yi-ju Chen, Jhongli City (TW); Shih-Chieh Hsu, Jhongli City (TW); Ching-Liang Lin, Jhongli City (TW)

Correspondence Address: HDSL, 4331 STEVENS BATTLE LANE, FAIRFAX, VA, 22033, US

(21) Appl. No.: 11/748,478

(22) Filed: May 14, 2007

(51) Int. Cl. B44C 1/22

(52) U.S. Cl. 216/99; 216/108

(57) ABSTRACT

A method of processing nature pattern on expitaxial substrate, unlike the conventional method of processing regular pattern on expitaxial substrate (such as sapphire substrate) by lithography, wet etches a sapphire substrate directly to obtain a nature pattern, so as to simplify the fabrication process. Compared with the conventional way of processing pattern sapphire, the nature pattern sapphire substrate produced by the method can avoid voids between the interface of sapphire and GaN and apply this technology to a wired bond LED structure to increase the sidewall light extraction and improve the texture of the sapphire surface of a flip chip LED structure. In addition, this method also can be applied to a thin-GaN LED for achieving the surface texture after the sapphire is removed by laser.

### FIELD OF THE INVENTION

The present invention relates to a method of processing pattern on expitaxial substrate, and more particularly to a method of applying an etching liquid on the surface of an expitaxial substrate (such as a sapphire substrate) for processing a nature pattern. Unlike the conventional method of adopting a lithography process, the present invention provides a nature pattern on a sapphire substrate (in a regular cylindrical or rectangular pattern). By applying an etching liquid on the surface of a sapphire substrate, the shape of a nature pattern (such as a pyramid shape) can be achieved.

### BACKGROUND OF THE INVENTION

As integrated circuit (IC) products and technologies are developed rapidly, lithography technology plays a decisive role in the field of IC fabrication, and the main purpose of lithography is to transfer a pattern of a device onto a chip, by leveraging the property of a photoresist material that can change the bonding condition when exposed to light, and using a mask to duplicate the pattern of the mask onto a chip covered by a photoresist layer, and then removing a specific unprotected portion of the photoresist by a lithographic process to produce a predetermined shaped pattern of the device on the chip.

Etching is a process of removing a film that is not covered or protected by a photoresist through a chemical or physical reaction to achieve the purpose of evenly removing a material from an entire surface or transferring a pattern onto the film. Etching can be divided mainly into wet etching and dry etching, wherein wet etching removes an unprotected part of the surface of a device by chemical solutions and their reactions, and generally places a wafer into an etching tank that contains chemical solutions, and dry etching performs an etching process in a gaseous environment. In semiconductor fabrication, a reactive plasma source is generally used for dry etching. For pattern transfer, the etching process works together with the aforementioned lithography technology.

In present existing methods of processing a texture pattern on an expitaxial substrate such as a sapphire substrate, a photoresist layer is coated onto the surface of the sapphire substrate, and a pattern is formed by lithography, and then an unprotected part of the substrate is removed by dry etching or wet etching, and finally a pattern sapphire substrate is formed on the surface of the sapphire substrate. These methods are usually used in a wired bond structure of a conventional LED structure. Referring to FIG. 1, the surface of a sapphire substrate 1 includes the shapes of a positive-type gallium nitride (p-GaN) interface 11 and a negative-type gallium nitride (n-GaN) interface 12.

In a pattern sapphire substrate formed on the surface of a conventional sapphire substrate, the shape of a texture pattern is produced by lithography, and a nature pattern on the surface of the sapphire substrate is processed by dry etching or wet etching.

However, the conventional methods of processing a texture pattern on the surface of a sapphire substrate are limited by lithography, and thus the shape of the nature pattern of the pattern sapphire substrate is limited to circular, square and rectangular only, and the light extraction effect is restricted.

Further, the foregoing conventional way of producing the shape of a pattern by lithography and dry etching usually forms voids between the surface of sapphire substrate and the GaN interface, when an expitaxial is formed on vertical sidewalls of the substrate.

In view of the aforementioned shortcomings of the prior art, the inventor of the present invention based on years of experience in the related industry to conduct extensive researches and experiments and finally developed a method of processing a nature pattern on an expitaxial substrate in accordance with the present invention to overcome the shortcomings of the prior art.

### SUMMARY OF THE INVENTION

Since the conventional way of producing the shape of a pattern on a surface of an expitaxial substrate by lithography limits the texture surface of the pattern and the light extraction effect, improvements to overcome such limit are needed. If dry etching is adopted, silicon expitaxial will be formed on vertical sidewalls of the substrate to form voids between the sapphire and gallium nitride (GaN) interface, and thus the conventional method of processing nature pattern on expitaxial substrate definitely requires further improvements.

The present invention is to provide a method of overcoming the aforementioned shortcomings of the prior art (including the limitations on texture surface patterns and light extraction). Since the method in accordance with the present invention does not require any lithography process to obtain the natural shape of a nature pattern (such as a pyramid shape, a prism shape and a hexahedral shape), the invention not only simplifies the fabrication process, but also provides a natural shape of nature pattern by damaging the atomic bonds among atoms to different levels, and this method can be applied to an expitaxial substrate of a light emitting diode (LED) and a texture surface of a flip-chip structure, so as to achieve the effects of improving the light extraction of the light emitting diode (LED), providing a better external quantum efficiency, and increasing the light emitting intensity (as shown in FIG. 4). The invention also can be applied in a thin-GaN LED to achieve the effect of surface texture after the substrate is removed by laser.

### BRIEF DESCRIPTION OF THE DRAWINGS

FIG. 1 is a schematic view of a wired bond structure formed by a conventional method; and

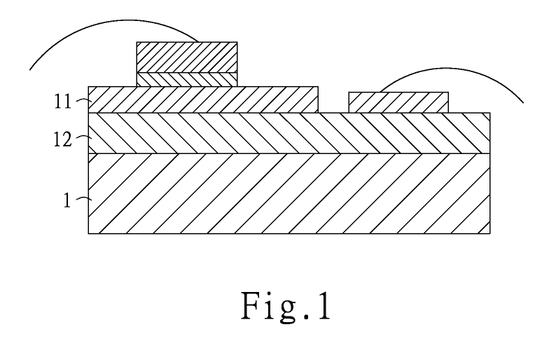

FIG. 2 is a schematic view of experiment results showing the patterns formed on a surface of an expitaxial (sapphire) substrate by using an etching liquid in accordance with the present invention.

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

Unlike the conventional way of producing a pattern on the surface of an expitaxial substrate by lithography, a method of processing a nature pattern on an expitaxial substrate in accordance with the present invention applies an etching liquid directly onto the surface of an expitaxial substrate to process the nature pattern, so as to quickly obtain a natural shape of nature pattern, and damage grate planes or atomic bonds to different levels to obtain different natural shapes of the nature pattern. The nature pattern can be obtained without going through a lithography process.

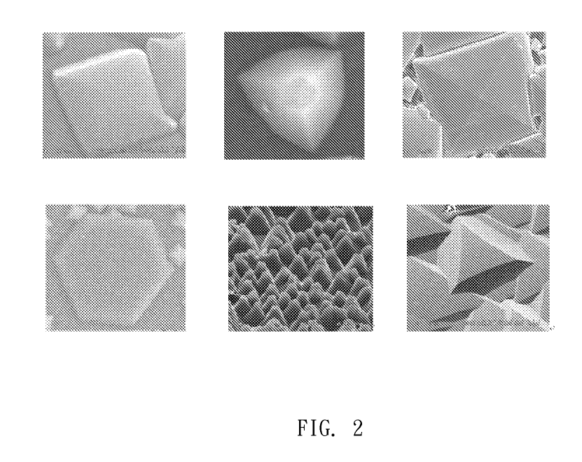

The shape of a nature pattern obtained by the aforementioned etching process can be a pyramid shape, a prism shape and a hexahedral shape. Refer to FIG. 2 for the experiment results showing the patterns formed on a surface of an expitaxial (sapphire) substrate by using an etching liquid in accordance with the present invention.

In the method of the present invention, the etching liquid is composed of an acidic solution, an alkaline solution, an organic solution or a mixed solution of the above in any proportion. The etching liquid is provided for etching at any temperature not limited to a fixed temperature only, and the acidic solution of the etching liquid is provided for etching for any etching time not limited to a fixed etching time only.

Further, the expitaxial substrate is not limited to a sapphire substrate only, but also can be a substrate made of silicon carbide (SiC), silicon (Si), zinc oxide (ZnO), gallium nitride (GaN) and gallium arsenide (GaAs).

The expitaxial material is not limited to a semiconductor compound such as gallium arsenide (GaAs) and gallium nitride (GaN) that contains the Groups III-V elements listed in the periodic table only, but the expitaxil material can also be zinc oxide (ZnO). The expitaxial order is not limited to an n-side up structure or a p-side up structure only.

In the method of processing a nature pattern on an expitaxial substrate in accordance with the present invention, an etching liquid is used to damage atomic bonds to different levels, since each chemical bond among atoms varies. After a nature pattern is formed, the silicon expitarixal not only reduces the occurrence of threading dislocations during an expitaxial process to enhance the quality of expitaxial such as gallium nitride (GaN) and the internal quantum efficiency, but also increases the light extraction of a light emitting diode (LED) to provide a better external quantum efficiency, so as to improve the light emitting intensity of the light emitting diode (LED).

Therefore, the method of processing a nature pattern on an expitaxial substrate in accordance with the present invention improves over the prior art and complies with the requirements of a patent application as follows:

1. The method of the present invention is novel. Unlike the conventional method that produces the shape of a pattern on a substrate (such as a sapphire substrate), the present invention uses an etching liquid to damage grate planes or atomic bonds to different levels, so as to produce different natural shapes for the nature pattern.

2. The method of the invention improves over the prior art. The method not only simplifies related fabrication processes, but also prevents the formation of voids between the interface of sapphire and gallium nitride (GaN) caused by the silicon expitaxial formed on vertical sidewalls of the substrate (which occurs frequently in a conventional dry etching process of the pattern) by means of a pyramid shaped pattern.

3. The method of the invention is useful. The method uses an expitaxial substrate of a light emitting diode (LED) to increase the light extraction at the sidewalls of the substrate and improve the light extraction by the texture surface of a flip chip. The invention also can be applied in a thin-GaN LED to achieve the effect of surface texture after the substrate is removed by laser.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method of processing nature pattern on expitaxial substrate, unlike a conventional way of using lithography to produce a shape of a pattern on an expitaxial substrate, using an etching liquid to process a nature pattern on a surface of an expitaxial substrate to obtain a natural shape of said nature pattern.

2. The method of processing nature pattern on expitaxial substrate as recited in claim 1, wherein said nature pattern is a pattern in a pyramid shape, a prism shape or a hexahedral shape.

3. The method of processing nature pattern on expitaxial substrate as recited in claim 1, wherein said etching liquid is an acidic solution, an alkaline solution, an organic solution, or a mixed solution of the above in any proportion.

4. The method of processing nature pattern on expitaxial substrate as recited in claim 1, wherein said etching liquid performs etching at a fixed temperature.

5. The method of processing nature pattern on expitaxial substrate as recited in claim 1, wherein said etching liquid is an acidic solution performs its etching within a fixed etching time.

6. The method of processing nature pattern on expitaxial substrate as recited in claim 1, wherein said expitaxial substrate is made of sapphire.

7. The method of processing nature pattern on expitaxial substrate as recited in claim 1, wherein said expitaxial substrate is made of silicon carbide (SiC), silicon (Si), zinc oxide (ZnO), gallium arsenide (GaAs) or gallium nitride (GaN).

8. The method of processing nature pattern on expitaxial substrate as recited in claim 1, wherein said expitaxial substrate is made of a semiconductor compound of zinc oxide (ZnO) and gallium arsenide (GaAs) that contains the Groups III-V elements listed in the periodic table.

9. The method of processing nature pattern on expitaxial substrate as recited in claim 1, wherein said expitaxial growth order is in an n-side up structure or a p-side up structure.
